(19) United States
(12) Patent Application Publication
(10) Pub. No.: US 2009/0177646 A1
(43) Pub. Date: Jul. 9, 2009

(54) Plug-In for Health Monitoring System

(75) Inventors: Bernard Pham, Kirkland, WA (US); Israel Hilerio, Kenmore, WA (US); Shadi Ashkar, Sammamish, WA (US); Simon Leet, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/971,905

(22) Filed: Jan. 9, 2008

(51) Int. Cl. G06F 17/30

(52) U.S. Cl. 707/5; 707/E17.014

(57) ABSTRACT

A monitoring and management system may use a plugin mechanism to add or update an interface to a managed service or device. The plugin may have capability to interface with the managed service or device, as well as an interface to a status database that may be populated by the managed service or device as well as other services or devices. The plugin may have rules that may be used to determine a status for the monitored service or device based on the statuses of several services or devices, and may also have rules that define a multi level query into the database to determine those services and devices.

### BACKGROUND

Monitoring and management systems may be used to manage many services and devices across a network. One aspect of such systems may be to monitor the performance or ‘health’ of a service or device. In a typical usage scenario, such a system may manage multiple server devices within a local area network environment where several servers may operate various services such as email and messaging, application hosting, file storage, network connectivity and security, and other services.

Many different services and devices may be monitored and managed, with each service or device may be added or updated periodically. In many management systems, the management system may be updated with each addition or revision of a managed service. This may cause a delay in implementing the new service while an update to the management system may be created and distributed.

### SUMMARY

A monitoring and management system may use a plugin mechanism to add or update an interface to a managed service or device. The plugin may have capability to interface with the managed service or device, as well as an interface to a status database that may be populated by the managed service or device as well as other services or devices. The plugin may have rules that may be used to determine a status for the monitored service or device based on the statuses of several services or devices, and may also have rules that define a multi level query into the database to determine those services and devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with an extensible management console.

FIG. 2 is a diagram illustration of an embodiment showing a management console.

FIG. 3 is a flowchart illustration of an embodiment showing a method for operating an extensible management console.

FIG. 4 is a flowchart illustration of an embodiment showing a method for connecting to a status database.

FIG. 5 is a diagram illustration of an embodiment showing a plug-in to an extensible management console.

### DETAILED DESCRIPTION

An extensible management console may use plugin applications to interface with and control various devices, services, and applications. The plugin applications may be used to create additional user interfaces within the extensible management console as well as querying a status database that may be populated by the monitored devices, services, and applications.

The plugin applications may include status database queries, which may enable the extensible management console to be updated and maintained on a piece-by-piece basis, as opposed to releasing and maintaining a large, monolithic management application. The plugin applications may be periodically updated, replaced, or added, thereby enabling extensive updates to be implemented simply and quickly.

The extensible management console with plugin applications represents a flexible and easily updatable architecture for a management application. The core management console may support specific management functions to be implemented in each plugin application. Since the plugin applications are able to communicate with devices and services under management, as well as perform queries to a status database, each plugin may add complex and useful features to the console, yet may be added or updated without affecting other plugin applications.

The status database may be part of an application or service that collects status and performance data from several different sources. In some cases, the status database may periodically query or monitor the monitored device or service, while in other cases, the monitored device or service may periodically transmit status or performance data to the status database.

In many embodiments, a monitoring server and status database may be part of a network based monitoring system used to continually collect status and performance data from many different sources across the network. In some cases, a monitoring server and status database may have a standalone monitoring application.

The plugin may provide a connection and command interface to a monitored service as well as a rule based logic for interfacing with the monitoring server. In many cases, a query to the monitoring server may include a multilevel query that may be used to isolate a set of parameters for monitoring the particular service or device.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, microcode, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

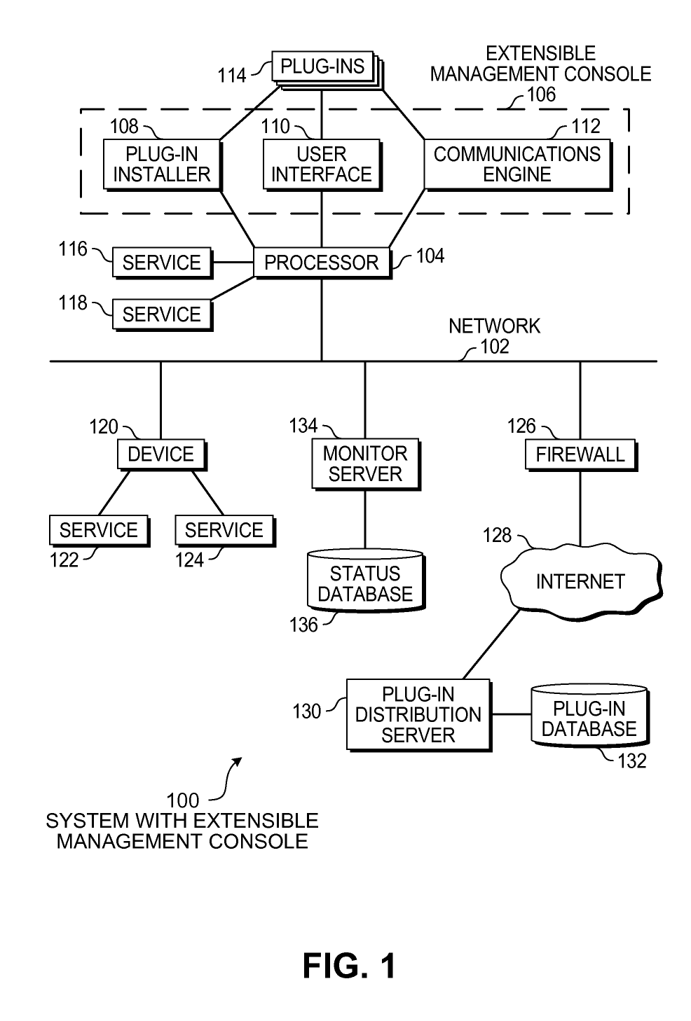

FIG. 1 is a diagram of an embodiment 100 showing a system with an extensible management console. Embodiment 100 is an example of a system that may use plugins with an extensible management console to interface with and control various devices and services, as well as interface with a status database.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

A network 102 may have a device with a processor 104 that operates an extensible management console 106. The extensible management console 106 may be used to install, configure, manage, and monitor various services and devices connected through the processor 104 as well as the network 102. In many cases, the extensible management console 106 may be able to interface with various data collection devices that may monitor the status and performance of the monitored devices and services.

The extensible management console 106 may be an extensible platform that may use plugins 114 to perform various activities for a monitored device or service. The extensible management console 106 may include a plugin installer 108, a user interface 110, and a communications engine 112. In some embodiments, an extensible management console 106 may include many other components and features.

The plugin installer 108 may be capable of receiving a plugin and installing the plugin to work with the extensible management console 106. Each embodiment may have different mechanisms for installing a plugin. In many cases, a plugin may have several components that may be unpacked and installed in various locations for the extensible management console 106 to access. In some cases, a plugin may be a self-contained file, directory, or a group of files that are stored in a location that may be accessible by the extensible management console 106.

The plugin installer 108 may be capable of determining that a service is operating on the network and retrieving a plugin that is suited to communicate with the service. The plugin installer 108 may make the plugin available to a user who may approve or cancel the installation of the plugin. In such an embodiment, the plugin installer 108 may have a discovery mechanism to determine that a service or device exists on the network 102 that may be controlled.

The discovery mechanism may operate in various fashions. In one instance, the discovery mechanism may have various monitoring agents that monitor network traffic, perform specific queries across the network, or probe various devices for services that could be monitored. In another instance, the discovery mechanism may perform periodic queries of a monitoring server 134 that may have a status database 136 to determine if services that could be monitored are located on the network.

In many embodiments, the monitor server 134 and status database 136 may be used to collect status and performance data for many different services and devices. For example, a service such as a domain name service (DNS) or a messaging service may be configured to send status messages to the monitor server 134 on a periodic basis. In some cases, a service may transmit a message on a generally uniform pattern, such as every hour or every day. The message may include performance data such as the number of email messages transmitted, the number of failed queries, or other status information that may be specific to the type of service. In other embodiments, a service may be configured to send messages to the monitoring server asynchronously, such as whenever a specific action is taken, whenever a failure occurs, or whenever some predefined condition is met.

The monitoring server 134 may be capable of monitoring any type of device, service, application, or other monitor-able item connected to the network. In some cases, a service may be configured to connect to the monitor server 134 and transmit status or performance data. In other cases, a monitoring agent may be operable on a device and capable of collecting status and performance data and transmitting the data to the monitoring server 134. In still other cases, the monitoring server 134 that may have a data collection service that may monitor network traffic, query various devices and services, and collect some data for storage in the status database 136.

The plugin installer 108 may communicate with a plugin distribution server 130 that may have a plugin database 132. Such a communication may go through a firewall 126 and the internet 128. Each embodiment may have different network topologies and connection mechanisms, and the network topology of embodiment 100 is merely for example purposes.

The plugin distribution server 130 may provide several services for the plugin installer 108, including cataloging, downloading, configuring, and updating. The cataloging service may include providing the plugin installer 108 with an updated list of plugins and the services or devices supported by the plugins. In such a service, the plugin installer 108 may subscribe to a periodically updated catalog of supported services and devices. In some cases, the cataloging service may include a mechanism by which the plugin installer 108 may perform a query against the plugin database 132 to locate a plugin for a particular application.

In some cases, the plugin distribution server 130 may send out periodic notices when a new plugin is available. In such a case, the plugin distribution server 130 may transmit a message to the plugin installer 108 indicating that a new plugin is available.

The plugin distribution server 130 may provide downloading services for a plugin that may be requested. Various mechanisms may be used to download a plugin, such as File Transfer Protocol (FTP) or other downloading mechanisms. In some cases, the plugin distribution server 130 may send a requested plugin by email or some other messaging system.

In some embodiments, a plugin may be installed on an extensible management console 106 and may have a secondary configuration operation that may configure specific parameters of the plugin so that the plugin may operate properly with a specific service or device. In such an embodiment, the plugin installer 108 may perform a query to the plugin distribution server 130 with specific parameters about a specific monitored service or device, to which the plugin distribution server 130 may respond with a tailored set of parameters for the monitored service or device.

The plugin distribution server 130 may provide periodic updating services to the plugins 114 using the plugin installer. When an updated version of a plugin is available, the plugin distribution server 130 may transmit the updated plugin to the plugin installer 108. In some embodiments, the plugin installer 108 may periodically query the plugin distribution server 130 to determine if an updated plugin is available.

The user interface 110 may use various plugins 114 to create screens or views through which a user may interact with the extensible management console 106. In some embodiments, a page, view, or section of a user interface may be defined by a plugin. In some embodiments, the extensible management console 106 may extract information from a plugin 114 to create portions of a user interface that may be displayed for a user.

In many cases, the user interface 110 may include controls for inputting commands to a monitored service or device as well as data or information collected about the monitored service or device. The controls may be used to generate commands that may be sent to the service or device through a communications engine 112. Similarly, the communications engine 112 may be able to query the service or device as well as the monitor server 134 to gather data for display with the user interface 110.

The communications engine 112 may be able to establish communications with a monitored service as well as the monitor server 134. Communications with the monitored service or device may include transmitting commands or queries and receiving data. In many cases, the monitored service or device may be adapted to transmit more detailed or more up to date information to the monitor server 134 that may store the data in the status database 136. In such cases, the communications engine 112 may obtain status or performance data through the status database 136 rather than from the service itself.

In many embodiments, the status database 136 may include status and performance data from many different sources. As such, the communications engine 112 may be able to run a query against the status database 136 and determine more useful information than if a query was performed against a monitored service. For example, a monitored service may be operating properly but may be operate on a server device that has a very full disk storage system. Because the disk storage system is full, the overall performance of the server device is degraded. A simple query to the service may return a result that the service is properly functioning, but a more complex query to the status database 136 may return a result that includes the status of the server device on which the service depends. The summation of both the service status and server device status may have a more meaningful result.

The processor 104 may be part of a device such as a personal computer, server computer, network appliance, or some other network enabled device. The processor 104 may operate the extensible management console 106 as well as services 116 and 118 that may be monitored using the extensible management console 106. Similarly, device 120 may also provide services 122 and 124 that may be monitored by the extensible management console 106.

The extensible management console 106 may monitor services such as operating system or application services that may be continually or periodically operable on a processor or device. In many cases, the extensible management console 106 may be used to monitor devices, including hardware and software aspects of a device. In such cases, a monitoring agent located remotely or operable on the device may collect various data and various commands may be created by and transmitted from the extensible management console 106 and executed by the device.

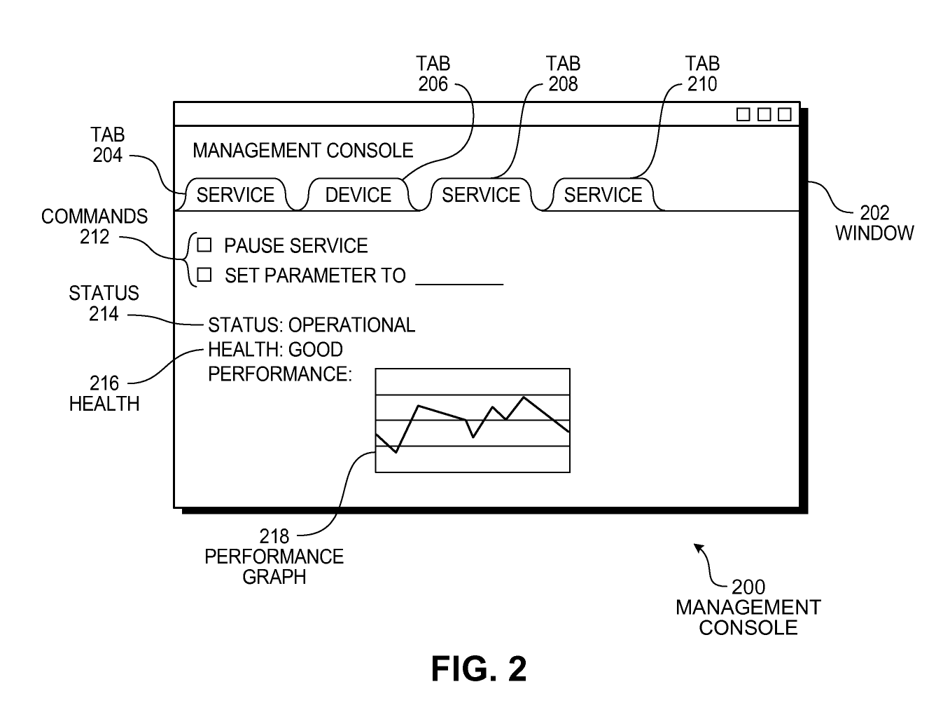

FIG. 2 is a diagram illustration of an embodiment 200 showing a user interface for an extensible management console. Embodiment 200 is merely a simplified example of the various components that may be found within a user interface. Each embodiment may have different layout, look and feel, and specific functionality.

The window 202 may be displayed on a computer user interface and may be used by a user to interact with the various services and devices monitored and controlled by an extensible management console.

The window 202 may include several tabs 204, 206, 208, and 210 that may each refer to a separate plugin that may be installed in an extensible management console. As a plugin is installed, a new tab may be created and added to the management console. When a user selects a tab, such as tab 208 that is currently selected, the user may view specific user interface items that relate to the monitored service.

In many embodiments each tab may be presented with an indicator for the monitored service. For example, tab 204 has a ‘service’ designation. In a typical embodiment, the term ‘service’ may be replaced with the specific name of a monitored service, such as ‘DNS Service’. Similarly, tab 206 has a ‘device’ designation. In a typical embodiment, the term ‘device’ may be replaced with ‘File Server System’ or some other designation.

The user interface for a particular service may include several different items. Commands 212 may be any type of user interface mechanism by which a user may interact with the monitored service or device. In some cases, the commands 212 may be user interface devices such as buttons, drop down lists, text input boxes, command line interface, or any other user interface device by which a user may select an action. From the user input, a command may be fashioned that may be transmitted to the monitored service or device and executed. In some cases, a user may not recognize that a command may be created and executed by the monitored service or device.

Status indicator 214 and health indicator 216 may be summary information that is gathered from various sources. In some cases, a query may be performed against the monitored service while in other cases, a query may be performed against a status database. In some cases, queries to both the monitored service and status database may be performed.

In many embodiments, a plugin may define status and health indicators for a monitored service using a set of parameters derived from a status database that may include parameters from different services and devices. For example, a status or health indicator for a service or application may include status information from a device on which the service operates or for a service on which the monitored service may depend. Such information may be obtained from a centralized status database that may collect status and performance data from many different services and devices.

The embodiment 200 may include a performance graph 218 that may include specific performance data for the monitored service or device. In some cases, the performance data may be real time or near real time, and in other cases the performance data may be historical data that are collected over time. In some embodiments, a status database may collect and store such historical data.

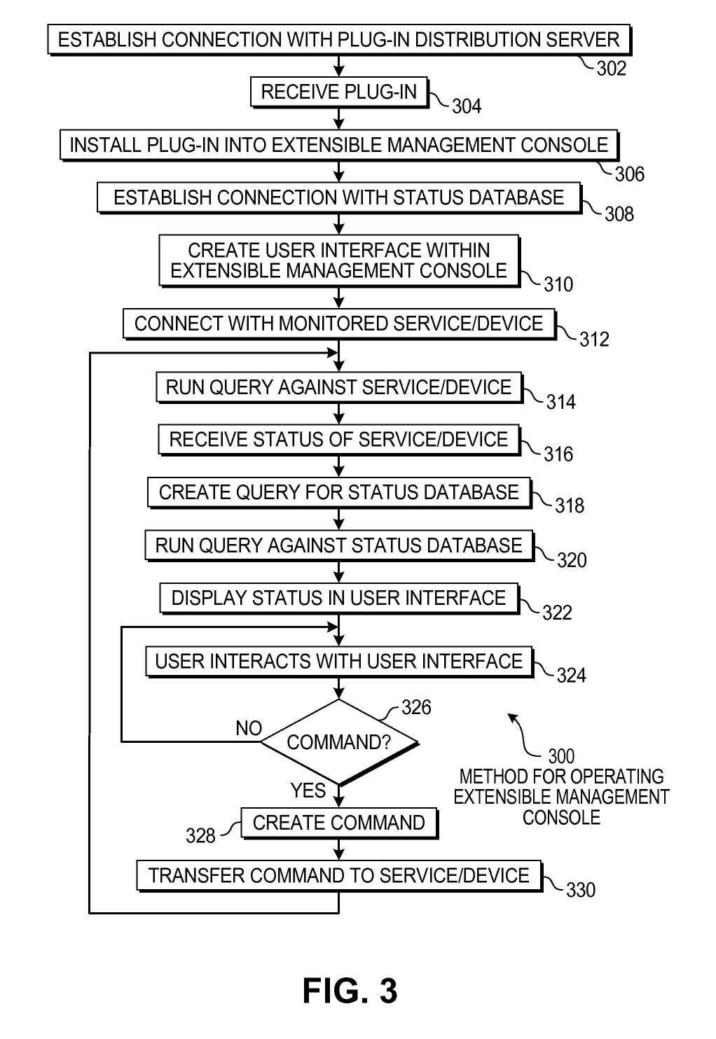

FIG. 3 is a flowchart illustration of an embodiment 300 showing a method for operating an extensible management interface. Embodiment 300 is an example of a method for operating an extensible management interface, and other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A connection may be established with a plugin distribution server in block 302 and a plugin may be received in block 304. An extensible management console may connect with a plugin distribution server in many different fashions and using different logic.

In one embodiment, an extensible management console may locate a plugin distribution server through an internet address. In some cases, the console may initiate a communication and download a catalog or listing of available plugins. The console may use the catalog of plugins to identify services or devices that may be monitored and controlled. When a service is identified, the console may request and download an applicable plugin from the plugin distribution server. Other embodiments may have different methods for communicating and transmitting plugins for installation.

The plugin may be installed into the extensible management console in block 306. In some embodiments, the plugin related files may be stored in a folder or directory that may be monitored by the extensible management console. In such an embodiment, the console may detect that a plugin is available and incorporate the plugin into the console. Such operations may happen periodically or when the console is started.

In other embodiments, an installer may unpack a plugin and install various components in different locations. Such an embodiment may make changes to configuration files or registries, move files to specific directories, or some other actions.

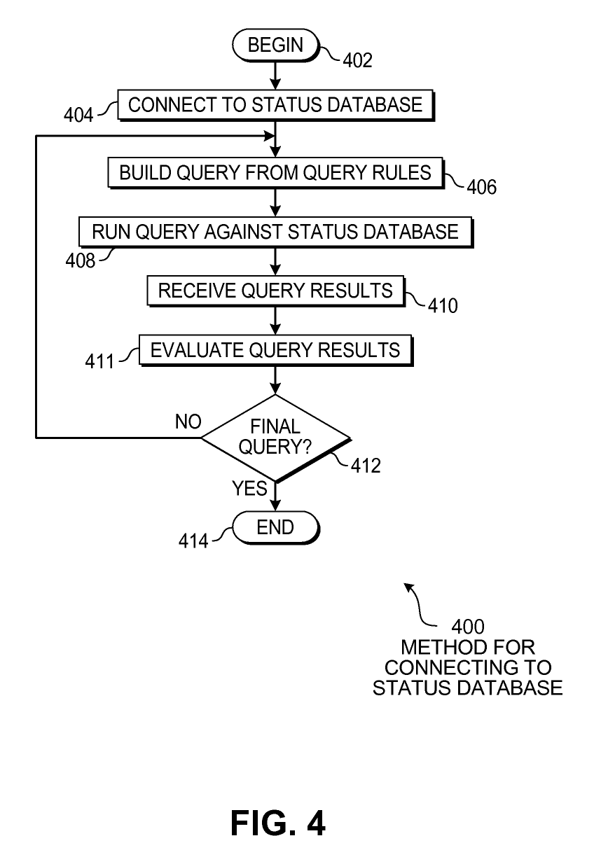

A connection to a status database may be made in block 308. An example of a multilevel query for a connection to a status database is illustrated in FIG. 4, discussed later in this specification. In many embodiments, an initial connection to a status database may include developing a specific query for a service or device that takes into account dependent services or devices. The specific query may be created by using a set of rules that may assist in detecting dependent services or devices and including references to the dependent services or devices in a query or set of queries used for a monitored service.

A user interface may be created within the extensible management console in block 310 using the plugin information. In some embodiments, a plugin may include components that may be used by a console to generate a user interface. Such components may include text, images, and user interface devices such as buttons, pull down menus, selectors, or other devices. Components may include indicators such as colored buttons, graphs, dials, or other visual components that are driven by collected data and communicate status or health of a monitored service or device.

In many embodiments, a plugin may include layout information for the user interface. For example, a user interface may be defined using hypertext markup language (HTML) or some other markup language that may be interpreted by the console and used to format and present the user interface components.

The console may connect to the monitored service or device in block 312 and run a query against the service or device in block 314. The console may receive status or other information from the service or device in block 316. The extensible management console may use information from a plugin to communicate with the monitored service or device.

Communication between an extensible management console and a monitored device or service may occur in several different manners. In some embodiments, the monitored device or service may have a communications mechanism such as an application programming interface (API) through which queries and commands may be processed. In other embodiments, a monitored service or device may have a communications engine that is capable of processing incoming messages and sending messages in response. In still other embodiments, an agent, daemon, or other application may operate to monitor a device or service. In such an embodiment, the console may communicate with the agent or daemon. Other embodiments may have different mechanisms for communicating between the console and the monitored service or device. In some embodiments, a combination of mechanisms may be used.

The console may create a query for a status database in block 318, and run the query against the status database in block 320. The status received from the status database may include historical data, status information for dependent or other related services or devices, and other information. The status received from the monitored service or device in block 316 may be more or less detailed than the status received from the status database in block 320. In many embodiments, different information may be available from a query to the monitored device or service and a query to the status database.

The status information may be displayed in block 322. In many cases, the status information displayed within an extensible management console may be summarized data. Such data may be created by analyzing the various status data from the monitored service or device as well as the data obtained from a status database. Such data may be processed, summarized, and analyzed prior to being displayed within the extensible management console. In many embodiments, a user interface may enable a user to drill down various levels of detail to examine some of the underlying data that may be used to generate summary data that may be initially displayed.

The user may interact with the user interface in block 324. In many cases, the user may be able to survey data, drill down into underlying data, read the status reports, or perform other functions without issuing a command in block 326.

When a command is selected in the user interface in block 326, a command may be generated in block 328 and transferred to the monitored device or service in block 330. A command may be any message that may be generated from the user interface and transmitted to the monitored device or service. In many cases, the command may be a change that may affect the status of the device or service, and thus the process may return to block 314, where the status may be updated.

FIG. 4 is a flowchart illustration of an embodiment 400 showing a method for connecting to a status database. Embodiment 400 is an example of a method that may use a hierarchal query mechanism to query the database, and other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The method begins in block 402. A connection is made with the status database in block 404.

A query may be built from a set of query rules in block 406 and run against the database in block 408. The results may be received in block 410 and evaluated in block 411. If the query is not the final query in block 412, the process repeats at block 406. If the query is the final query in block 412, the process ends in block 414.

Embodiment 400 illustrates a hierarchical query that may be defined by a set of query rules and run against the status database. In many embodiments, a hierarchical query may be used to determine various dependent or related services or devices for a monitored service or device. For example, a hierarchical query may be used to determine a device on which a monitored service operates. The health of the monitored service may include health parameters from the device on which the monitored service executes. In another example, a hierarchical query may be used to determine several services on which a monitored messaging service may depend as well as the devices on which those dependent services operate.

In many cases, a set of rules may be defined for a particular monitored device or service that may be used to generate a hierarchical set of queries for a status database. In a simplified example of a hierarchical query, a first level of query may determine a device on which a monitored service executes. A second level of query may determine what other services operate on the device. A third level of query may determine how which of various hardware resources are used by each of the services on the device, including the monitored service. A fourth level of query may determine the status of the hardware resources used by the monitored services. When a status is calculated or determined for the monitored service, a status may comprise the status of the individual hardware components used by the monitored service, the overall status of the device, and the status of the various other services operating on the device.

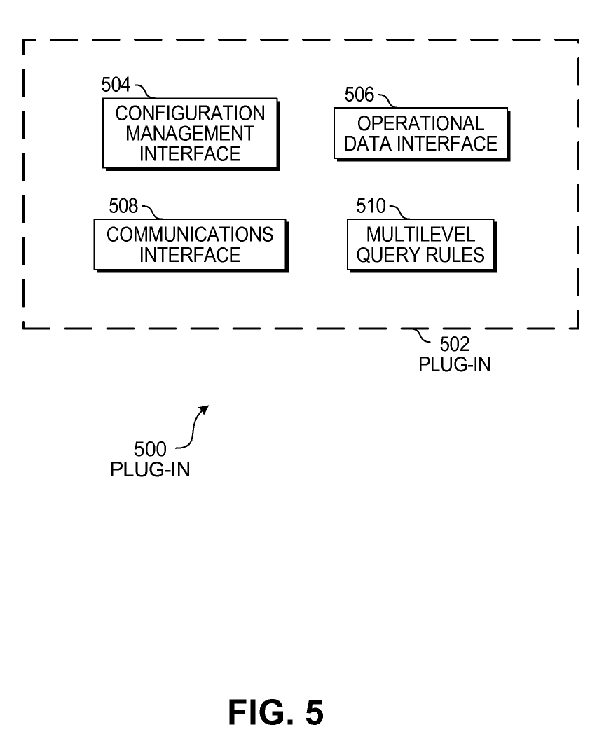

FIG. 5 is a diagram illustration of an embodiment 500 showing the functional components of a plugin. Embodiment 500 is an example of the functional components that may be found in a plugin. Other embodiments may use different terminology or nomenclature, and some other embodiments may divide the various functional components in different fashions by consolidating functions in different manners or separating functions into discrete units. As shown, the embodiment 500 is an example of the functional areas of a plugin and is meant as a simplified example.

The plugin 502 may contain a configuration management interface 504, an operational data interface 506, a communications interface 508, and a set of multilevel query rules 510.

The configuration management interface 504 may be used by an extensible management console to create a user interface. In many cases, the configuration management interface 504 may include definitions for various user interface components, including display devices such as text, graphics, charts, or other indicators, as well as input devices such as buttons, switches, sliders, drop down lists, menus, or other input devices. Some embodiments may include a layout definition that may be written in a markup language or some other layout definition.

In some embodiments, the configuration management interface 504 may include various analysis routines that may be used to analyze query responses to determine various parameters or status indicators to display. For example, a single health indicator may be displayed in a user interface to give a quick indicator of the performance and status of a monitored device or service. The health indicator may be determined by a set of rules, a formula, or an algorithm that summarizes the status of the monitored device or service plus the status of related or dependent devices or services.

The operational data interface 506 may be used by an extensible management console to perform various queries against a status database. In many cases, the operational data interface 506 may comprise a set of queries that may be tailored to solicit various status data from a monitored device or service. The operational data interface 506 may also be used to perform queries against the monitored device or service. In some instances, some status information such as detailed configuration information or up to date status information may be obtained through queries performed against the monitored device or service while more general status information or historical performance data may be obtained through a status database query.

The operational data interface 506 may use the multilevel query rules 510 to perform a hierarchical query of the status database. The multilevel query rules 510 may contain a hierarchical query structure or other logic that may enable the operational data interface 506 to navigate the status database to identify related or interdependent devices and services for a monitored service.

The communications interface 508 may include information that may be used to establish communications paths with the status database as well as the monitored device or service. The communications interface 508 may include a monitoring agent, daemon, or other application that may operate on a monitored device or in conjunction with a monitored service. In such instances, the communications interface 508 may be capable of installing the monitoring agent, daemon, or other application on the monitored device and performing various communications task with the agent.

The communications interface 508 may be used by an extensible management console to send queries and receive responses from the monitored device or service. In some embodiments, the communications interface 508 may include command sequences that may be used to query specific aspects of a device or service as well as cause the device or service to perform various functions. Each embodiment may have different communications mechanisms, protocols, and procedures, and some embodiments may use several different communications techniques within a single plugin.

Many embodiments may have an interface to a status database within the communications interface 508. Such an interface may be specially adapted to one or more specific status databases and may include very specific queries, scripts, sequences, or procedures that take advantage of various characteristics of the status database.

The communications interface 508 may enable two way communications with the monitored device or service as well as two way communications with the status database. The communications interface 508 may include various scripts or logic for creating a query or command that may be interpreted by a monitored device or status database, as well as scripts or logic for receiving a response and interpreting the response in a manner that may be used by other portions of the plugin or by the extensible management interface.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a network connection;
a plugin installer adapted to receive an install a plugin, said plugin being adapted to monitor and control a first service;
a user interface adapted to create a portion of said user interface using said plugin to generate a command for said first service;
a communications engine adapted to receive said command for said service and transmit said command to said first service, said communications engine further adapted to receive a query, send said query to a status database comprising status data from said first service, and receive a query result; and
said user interface being further adapted to display at least a portion of said query result.

2. The system of claim 1, said network connection being to a local area network.

3. The system of claim 2, said first service being provided by a server connected through said local area network.

4. The system of claim 2, said status database being a second service operable within said local area network.

5. The system of claim 1, said plugin being obtained through a plugin distribution server.

6. The system of claim 1, said portion of said user interface being accessed by a tab control within said user interface.

7. The system of claim 1, said status database having a monitoring interface having a second user interface.

8. The system of claim 1, said query comprising a status request for said first service and for at least one other service.

9. The system of claim 1, said query comprising a status request for said first service and for at least one device.

10. The system of claim 1, said communications engine adapted to perform a multilevel query with said status database.

11. The system of claim 10, said plugin comprising rules used by said communications engine to perform said multilevel query.

12. A method comprising:
receiving a plugin adapted to manage a first service;
installing said plugin into a extensible management console;
create a user interface in said extensible management console using said plugin;
receiving an input from said user interface;
creating a command for said first service based on said input;
transferring said command to said first service;
creating a query for a status database using said plugin;
transferring said query to said status database;
receiving a query result from said status database; and
displaying at least a portion of said query result in said user interface.

13. The method of claim 12, said plugin being received by a method comprising:
establishing a connection with a plugin distribution server; and
receiving said plugin from said plugin distribution server.

14. The method of claim 13, said connection being established by said plugin distribution server.

15. The method of claim 13, said connection being established by a method comprising:
contacting said plugin distribution server; and
requesting said plugin from said plugin distribution server.

16. A computer readable medium comprising computer executable instructions adapted to perform the method of claim 12.

17. A plugin comprising:
a configuration management interface adapted to create a user interface within an extensible management console, said user interface comprising at least one mechanism adapted to receive user input and create a command for a first service;
an operational data interface adapted to generate a query for a status database comprising status data from said first service;
a communications interface adapted to establish a connection with said first service and transmit said command to said first service, said communications interface being further adapted to establish a connection with said status database, transmit said query, and receive a query result, at least a portion of said query result being displayed using said user interface.

18. The plugin of claim 17 further comprising rules defining a multilevel query for said status database, said communications interface being adapted to use said rules to perform said multilevel query.

19. The plugin of claim 17, said query comprising a query for said first service and a query for a second service.

20. The plugin of claim 17, said query comprising a query for said first service and a query for a device.
